(19) United States
(12) Patent Application Publication
(10) Pub. No.: US 2025/0250088 A1
(43) Pub. Date: Aug. 7, 2025

(54) STORAGE CONTAINER, MANUFACTURING METHOD OF STORAGE CONTAINER, AND REUSING METHOD OF STORAGE CONTAINER

(71) Applicant: CANON KABUSHIKI KAISHA, Tokyo (JP)

(72) Inventors: EIJI OKADA, Tokyo (JP); SATOSHI IBE, Kanagawa (JP)

(21) Appl. No.: 19/044,920

(22) Filed: Feb. 4, 2025

(30) Foreign Application Priority Data
Feb. 7, 2024 (JP) 2024-016991

(51) Int. Cl. B65D 77/20; B41J 29/00

(52) U.S. Cl. CPC B65D 77/2024; B41J 29/00

(57) ABSTRACT

A storage container includes a main body including a storage portion having a space for containing a liquid cartridge and a peripheral edge portion forming an opening for containing the liquid cartridge in the storage portion, and a lid member covering the opening. The peripheral edge portion includes a surface facing the lid member, a welded portion on the surface and is welded to the lid member, and a structure having a first layer bonded to the surface and a second layer stacked on the first layer.

### BACKGROUND

### Field

The present disclosure relates to a storage container, a manufacturing method of a storage container, and a reusing method of a storage container.

### Description of the Related Art

When a product or the like is distributed in a market, the product or the like may be distributed while the product or the like is contained in a storage container. For example, a liquid ejection head that ejects ink is also distributed while the liquid ejection head is contained in a storage container during distribution in the market. A storage container for containing such a liquid ejection head is required to have durability for protecting a product from vibration during transportation and a drop impact during handling. Furthermore, in a form in which the liquid ejection head and an ink storage portion are integrated, it is required to suppress evaporation of ink from the liquid ejection head during distribution in the market. As a storage container for a liquid ejection head which satisfies such a requirement, a storage container is known in which a film-like lid portion is welded to an opening portion of the storage container and the opening portion is sealed.

In recent years, because reuse of resources is required for environmental consideration, the storage container is reused. When the storage container is reused, the number of times the storage container can be reused is generally limited from the viewpoint of maintaining durability of the storage container and reliability of protection of contents. For this reason, it is required that the number of times the storage container has been used can be determined.

As a method of determining the number of times a collected storage container has been used, for example, use of a non-contact type ID chip in which a manufacturing number of the storage container, management information regarding a stored object, and the like are stored is considered. However, there are issues that an increase in cost and additional equipment are necessary, compared to a case in which the storage container is not reused, such as an increase in cost due to introduction of the ID chip and necessity of a process of rewriting the ID chip. As a method of determining the number of times a storage container is reused, other than the use of ID chips, Japanese Patent Application Laid-Open No. 2012-145870 discloses a storage container in which the number of times the storage container has been used can be determined by breaking a projection provided on the storage container. Regarding the storage container described in Japanese Patent Application Laid-Open No. 2012-145870, it is possible to reuse a storage container that has not reached a limit of the number of times the storage container has been used, and to discard a storage container that has reached the limit of the number of times the storage container has been used.

However, in a configuration of Japanese Patent Application Laid-Open No. 2012-145870, it is necessary to break the provided projection in order to determine the number of times the storage container has been used, which increases the number of steps in a manufacturing process of the storage container.

### SUMMARY

The present disclosure is directed to providing a storage container of which the number of times of reuse can be easily determined, and a manufacturing method of the same.

According to an aspect of the present disclosure, a storage container includes a main body including a storage portion having a space for containing a liquid cartridge and a peripheral edge portion forming an opening for containing the liquid cartridge in the storage portion, and a lid member covering the opening, wherein the peripheral edge portion includes a surface facing the lid member, a welded portion on the surface and welded to the lid member, and a structure having a first layer bonded to the surface and a second layer stacked on the first layer.

According to another aspect of the present disclosure, a manufacturing method of a storage container including an opening, a main body having an peripheral edge portion forming the opening, and a lid member covering the opening includes preparing the main body and the lid member including a structure having a bonded layer, welding the lid member to the peripheral edge portion, and transferring the structure from the lid member to the peripheral edge portion.

Further features of the present disclosure will become apparent from the following description of exemplary embodiments with reference to the attached drawings.

### BRIEF DESCRIPTION OF THE DRAWINGS

FIGS. 1A and 1B are perspective views of a storage container to which the present disclosure can be applied.

FIG. 2A is a perspective view of a lid member before being welded to a main body in one exemplary embodiment of the present disclosure, and FIG. 2B is a cross-sectional view taken along a line IIb-IIb in FIG. 2A.

FIG. 3 is a cross-sectional view of a storage container in one exemplary embodiment of the present disclosure.

FIGS. 4A to 4C are diagrams each illustrating a manufacturing process of a storage container in one exemplary embodiment of the present disclosure.

FIGS. 5A and 5B are enlarged views each illustrating the manufacturing process in one exemplary embodiment of the present disclosure.

FIGS. 6A and 6B are enlarged views each illustrating a manufacturing process of a reused storage container in one exemplary embodiment of the present disclosure.

FIGS. 7A and 7B are enlarged views each illustrating a manufacturing process of a storage container in another exemplary embodiment of the present disclosure.

FIG. 8 is a view illustrating a manufacturing process of a storage container in another exemplary embodiment of the present disclosure.

FIGS. 9A and 9B are views each illustrating a manufacturing process of a storage container in another exemplary embodiment of the present disclosure.

FIGS. 10A and 10B are perspective views of a lid member in another exemplary embodiment of the present disclosure.

FIGS. 11A and 11B are enlarged views each illustrating a manufacturing process of a storage container in one exemplary embodiment of the present disclosure.

FIG. 12 is a perspective view of a storage container according to another exemplary embodiment of the present disclosure.

FIGS. 13A to 13C are enlarged views of a transfer portion in another exemplary embodiment of the present disclosure.

### DESCRIPTION OF THE EMBODIMENTS

Hereinafter, exemplary embodiments of the present disclosure will be described with reference to the drawings. Note that the following exemplary embodiments do not limit the present disclosure, and all combinations of features described in the present exemplary embodiments are not necessarily essential to solutions of the present disclosure. A relative arrangement, a shape, and the like of components described in the exemplary embodiments are merely examples, and not intended to limit the scope of the present disclosure. The same components are given the same reference numbers.

A storage container in one exemplary embodiment will be described. The storage container according to the present exemplary embodiment is a storage container for a liquid ejection head in which a liquid ejection head is contained when the liquid ejection head is distributed in a market. In the present exemplary embodiment, a storage container for a liquid ejection head will be described, but an object to be contained in the storage container is not limited to the liquid ejection head. For example, the storage container may be a storage container that contains a liquid cartridge for replenishing ink to a liquid ejection head (ink jet head) included in an ink jet printer or may be a liquid cartridge having a liquid ejection head.

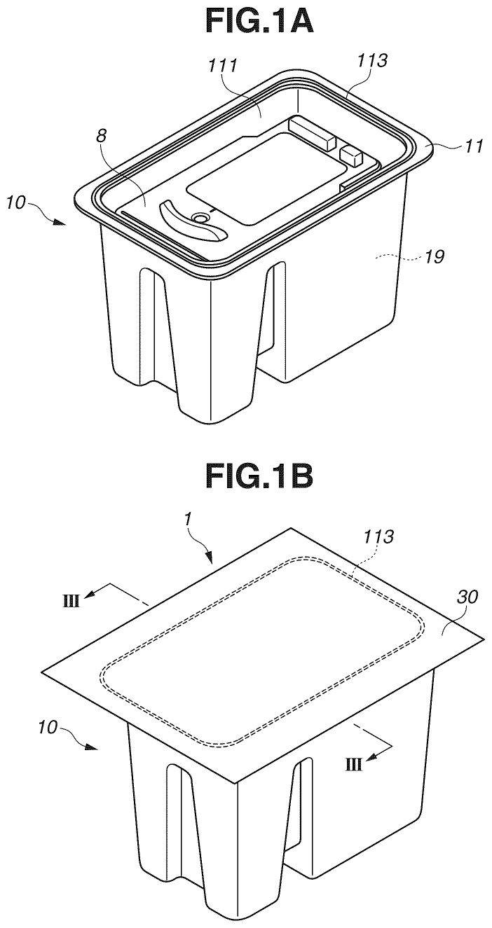

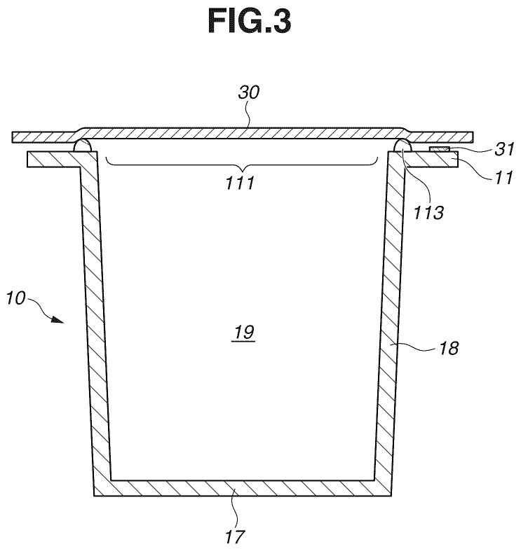

FIGS. 1A and 1B are perspective views each illustrating a storage container 1 according to the present exemplary embodiment. FIG. 1A is a perspective view before a lid member 30 is welded to a main body 10. The main body 10 has a storage portion 19 (see FIG. 3), and a liquid ejection head 8 as a storage object is contained in the storage portion 19. The main body 10 further includes a flange 11 as an peripheral edge portion, which forms an opening 111 through which the storage object is inserted into and removed from the storage portion 19. The configuration illustrated in FIG. 1A is an example, and the storage portion 19 may not have a substantially rectangular parallelepiped shape, and the opening 111 may not have a substantially rectangular shape.

FIG. 1B is a perspective view illustrating a state where the lid member 30 is welded to the main body 10 in the present exemplary embodiment. In a case where the liquid ejection head 8 is a liquid ejection head in which an ink storage portion for containing ink is integrated, it is preferable that the lid member 30 has a film shape with high sealability in order to suppress evaporation of ink from the liquid ejection head 8.

The flange 11 is a portion facing the lid member 30 covering the opening 111. In the present exemplary embodiment, the flange 11 is a portion to which the lid member 30 is attached. A projection 113 is provided on a surface of the flange 11 facing the lid member 30. The projection 113 is preferably formed continuously along the circumferential direction of the opening 111 in such a way as to surround the opening 111. Accordingly, it is possible to enhance the sealability in a state where the lid member 30 is welded to the projection 113. Like the flange 11, the peripheral edge portion forming the opening 111 in the main body 10 preferably has a flange shape protruding from a wall surface of the storage portion 19. As a result, an area of the peripheral edge portion (flange 11) facing the lid member 30 is increased, thereby making it possible to increase an area of a region facing the projection 113 to be described below and a transfer portion 31.

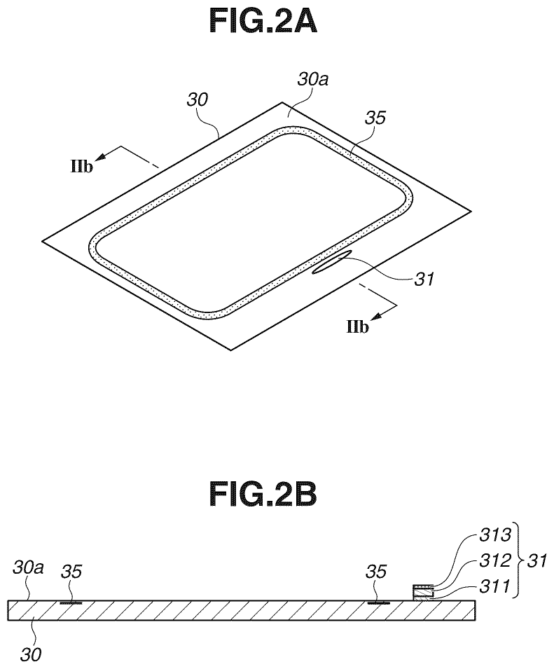

FIG. 2A is a view of the lid member 30 before being welded to the main body 10, as viewed from a surface 30a thereof on a side to be welded to the main body 10. One surface 30a of the lid member 30 is to be welded to the projection 113 of the main body 10. Namely, the projection 113 is a projection-shaped welded portion at which the main body 10 is welded to the lid member 30. FIG. 2A illustrates a welded region 35, which is a region of the surface 30a that is to be welded to the projection 113.

The transfer portion 31 is provided outside the welded region 35 of the surface 30a. As will be described below, the transfer portion 31 is a structure for recording the number of times the main body 10 has been used. A method of determining the number of times the main body has been used will be described below. FIG. 2B is a cross-sectional view taken along a line IIb-IIb in FIG. 2A. The transfer portion 31 provided outside the welded region 35 of the surface 30a has a structure in which a release layer 311, a fixing layer 312, and a bonded layer 313 are stacked in this order from the surface 30a. For the release layer 311, for example, a material such as an acrylic resin whose adhesion strength is reduced when heated can be used. For the fixing layer 312, for example, a material with little thermal deformation such as metal, paper, or resin can be used. For the bonded layer 313, for example, a material that melts when heated and bonds when cooled, such as a hot melt, can be used. From the viewpoint of adhesiveness between the flange 11 and the bonded layer 313, as an example, when the main body 10 is made of polypropylene (PP), the material of the bonded layer 313 is also desirably PP. When the main body is made of polyethylene terephthalate (PET), the material of the bonded layer 313 is also desirably PET.

When the lid member 30 is transparent, even in a state where the lid member 30 is welded to the main body 10, it is possible to read a state of the transfer portion 31 to be described below. The lid member 30 may have a tab portion with which the lid member is peeled off from the flange 11 in such a way that a user can easily take out the liquid ejection head 8 from the storage container 1.

FIG. 3 illustrates a cross section taken along a line III-III in FIG. 1B. The main body 10 includes a bottom portion 17 and a side wall portion 18 extending from the bottom portion 17. The side wall portion 18 may extend perpendicularly to the bottom portion 17, or may extend obliquely with respect to the bottom portion 17. A space surrounded by the bottom portion 17 and the side wall portion 18 is the storage portion 19. In the storage portion 19, a storage object such as the liquid ejection head 8 illustrated in FIG. 1A is stored, but illustration of the storage object is omitted in FIG. 3. As described above, the main body 10 has the opening 111 above the storage portion 19, and the opening 111 is closed by the lid member 30. The flange 11 projects outward from the side wall portion 18. A part of the projection 113 of the flange 11 is welded and brought into contact with the lid member 30, whereby the lid member 30 and the flange 11 are welded to each other. The transfer portion 31 transferred from the lid member 30 is arranged in a region on a side farther from the opening 111 than the projection 113 of the flange 11.

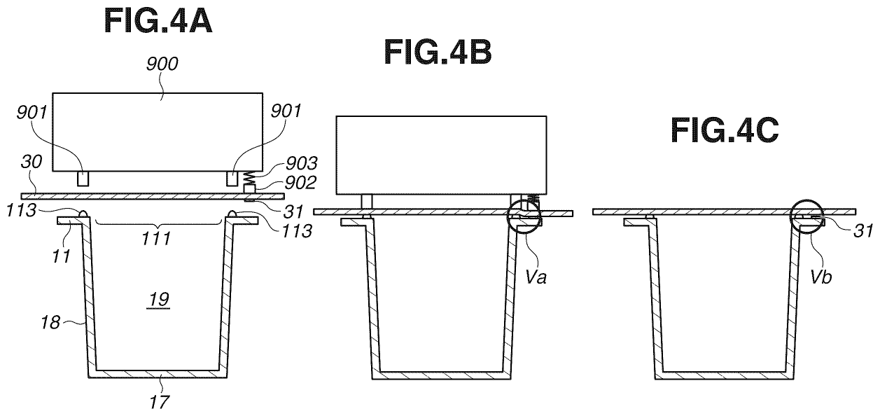

FIGS. 4A to 4C are cross-sectional views, each illustrating a manufacturing process of the storage container 1 in which the lid member 30 is welded to the main body 10 and the opening 111 is closed. In FIGS. 4A to 4C, similarly to FIG. 3, the illustration of the storage object is omitted. First, as illustrated in FIG. 4A, a welding jig 900 is arranged at a position facing the flange 11 of the main body 10. The welding jig 900 includes a welding horn 901 and a transfer horn 902 fixed via a spring 903. As illustrated in FIG. 4B, the welding jig 900 is lowered from the state illustrated in FIG. 4A to bring the lid member 30 into contact with the main body 10. At this time, the welding horn 901 melts a part of the projection 113 via the lid member 30, and welds the part to the lid member 30. At the same time, the transfer horn 902 pressed by the spring 903 applies heat to the transfer portion 31 via the lid member 30, and the transfer portion 31 is transferred from the lid member 30 to the flange 11. As illustrated in FIG. 4C, a state where the lid member 30 is welded in such a way as to close the opening 111 of the main body 10 is acquired by raising the welding jig 900 after the welding. At this timing, the transfer portion 31 is transferred to the flange 11.

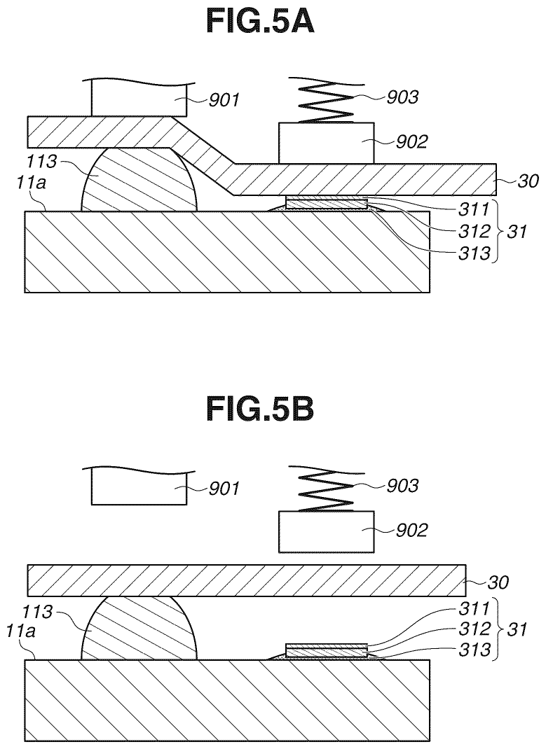

FIGS. 5A and 5B are enlarged views of the projection 113 and the vicinity of the transfer portion 31 in a welding process of the lid member 30. FIG. 5A is an enlarged view of a Va portion in FIG. 4B, and FIG. 5B is an enlarged view of a Vb portion in FIG. 4C. As illustrated in FIG. 5A, first, the lid member 30 is brought into contact with the tip of the projection 113 by a load applied by the welding horn 901. Then, the tip of the projection 113 is melted and welded to the lid member 30. The transfer portion 31 is pressed against the flange 11 by the load of the transfer horn 902 pressed by the spring 903. At this time, the bonded layer 313 is melted by heat, and the adhesion strength of the release layer 311 to the lid member 30 is reduced by heat.

As illustrated in FIG. 5B, when the transfer horn 902 is separated from the lid member 30, the bonded layer 313 is cooled and solidified, and bonded to the flange 11. At this time, since the adhesion strength of the release layer 311 is reduced by heating, the fixing layer 312 is peeled off from the lid member 30 and transferred to the flange 11 near the bonded layer 313. In FIG. 5B, the release layer 311 is attached to the fixing layer 312, but the release layer 311 may be separated from the fixing layer 312 and remain on the lid member 30.

When the liquid ejection head 8 as a storage object is taken out and used, the lid member 30 is peeled off from the main body 10. When the liquid ejection head 8 is collected after the liquid ejection head 8 is used, the liquid ejection head 8 can be collected while the liquid ejection head is contained in the main body 10 in order to prevent the liquid ejection head 8 from being damaged. Only the main body 10 may be collected. After the main body 10 is collected, the liquid ejection head 8 is stored in the main body 10 again, and a new lid member 30 is welded on, and the main body 10 is used again for containing and transporting the liquid ejection head.

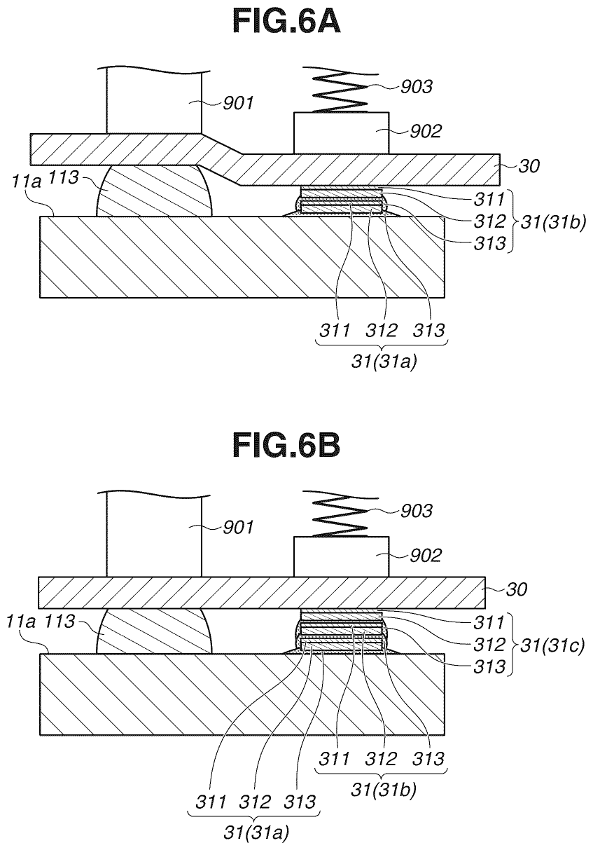

FIGS. 6A and 6B are views each illustrating a part of a process of welding the lid member 30 to the main body 10 that is collected and to be reused, and correspond to FIG. 5A illustrating a part of the welding process of the lid member 30 when the main body 10 is used for the first time. FIG. 6A illustrates the main body 10 for first reuse, and FIG. 6B illustrates a welding process of the lid member 30 to the main body 10 for second reuse.

As illustrated in FIG. 6A, the welding horn 901 melts a part of the projection 113 via the lid member 30 and welds the part to the lid member 30. At the same time, the transfer horn 902 applies heat to the transfer portion 31 via the lid member 30, and the transfer portion 31 (31b) is stacked and transferred from the lid member 30 onto the transfer portion 31 (31a) that has already been transferred to the flange 11. At this time, because a height of the projection 113 is lower than that at a time of first welding, a distance between the welding horn 901 and the flange 11 (a distance in a direction perpendicular to a surface 11a of the flange) is shorter, whereas a distance between the transfer horn 902 and the flange 11 is longer than that at the time of the first welding. Therefore, in the present exemplary embodiment, since the transfer horn 902 is connected to the welding jig 900 via the spring 903, the main body 10 can be welded to be reused and the lid member 30, using the welding jig 900 that is used at the time of the first welding.

Also in the main body 10 for second reuse, a new lid member 30 is to be welded to the main body 10 as illustrated in FIG. 6B. At this time, the height of the projection 113 is lower and the distance between the welding horn 901 and the flange 11 is shorter than those in the case of the first reuse illustrated in FIG. 6A, whereas the distance between the transfer horn 902 and the flange 11 is longer. However, as described above, in the present exemplary embodiment, since the transfer horn 902 is connected to the welding jig 900 via the spring 903, the main body 10 for the second reuse can be welded to the lid member 30, by using the same welding jig 900 as that used at the time of the first welding.

In FIGS. 5A and 5B and FIGS. 6A and 6B, an example in which the welding jig 900 including the welding horn 901 and the transfer horn 902 fixed via the spring 903 is used is illustrated, but the present disclosure can be suitably used even when a welding jig having a configuration different from that of the present exemplary embodiment is used.

As illustrated in FIGS. 5A and 5B and FIGS. 6A and 6B, a height of the transfer portion 31 that has been transferred to the flange 11 changes depending on the number of times the main body 10 is reused. For this reason, the number of times the main body 10 has been used at the time of collection can be determined from the state of the transfer portion 31 on the flange 11.

In the determination of the state of the transfer portion 31, it is possible to use measurement by a sensor or the like or reading by a reader or the like, and it is also possible to make a determination visually. For ease of visual recognition, it is desirable that the fixing layer 312 of the transfer portion 31 be thick. To be specific, as a size that can be determined by naked eyes, one fixing layer 312 is preferably 0.1 mm or more in thickness, and is more preferably about 0.1 to 0.3 mm.

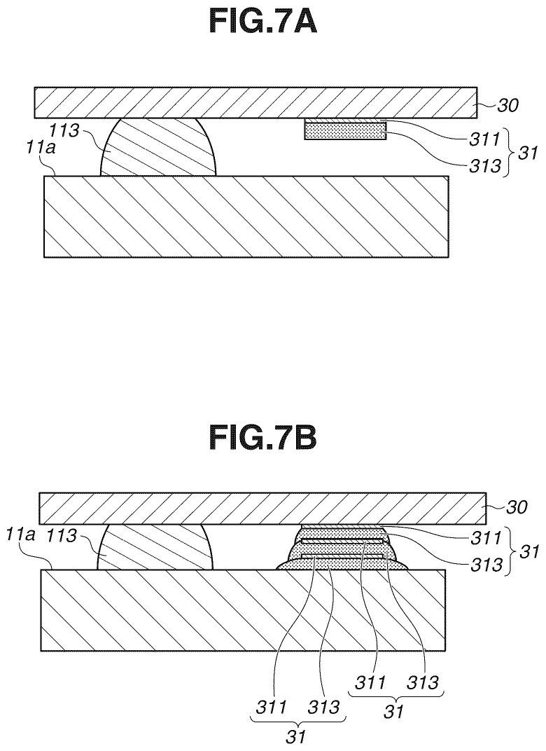

The transfer portion 31 may not include the fixing layer 312. FIGS. 7A and 7B are enlarged views of a welded portion between the projection 113 and the lid member 30 in a case of using a transfer portion 31 including the release layer 311 and the bonded layer 313 and not including the fixing layer 312. In each view, a state where a projection 113 of the lid member 30 is welded is illustrated. FIG. 7A illustrates a state immediately before the lid member 30 is welded to the projection 113 of a new main body 10, and FIG. 7B illustrates a state where a new lid member 30 is welded to a main body 10 that is reused for the second time. As illustrated in FIG. 7B, it is also possible to use a configuration in which the bonded layer 313 of the transfer portion 31 maintains a height to an extent that the number of times the main body is reused can be visually recognized even after the transfer portion 31 is bonded to the flange 11. To be specific, as the size that can be determined by naked eyes, one transfer portion 31 is preferably 0.1 mm or more in thickness, and more preferably about 0.1 to 0.3 mm.

When the main body 10 is reused, an upper limit of the number of times the main body is reused is often set. As in the present exemplary embodiment, in a blister pack in which a film-like lid member is welded to seal the storage portion in which contents are stored, which requires low cost, when the welding of the lid member is repeated a plurality of times, it may be difficult to peel off the lid member when the contents are taken out. This is because due to welding of the lid member a plurality of times, the welding surface of the flange becomes deformed or the height of the projection 113 (welding projection) is decreased, thereby bringing the film-like lid member into contact with a portion other than the welding portion (projection) and widening a welding area.

Under such circumstances, in order to reuse the blister pack as the storage container while suppressing the cost, it is important to maintain reliability of packaging by setting the upper limit of the number of times the lid member is welded to, for example, about three times. The consideration of the packing reliability also includes preventing stress from being applied to a customer without deterioration in sealing reliability of packing nor difficulty in peeling off of the film-like lid member.

In a case where the liquid ejection head, which is a content, is also reused by refilling ink, there is an upper limit to the number of times the liquid ejection head is reused from the viewpoint of durability of the liquid ejection head. For this reason, it is necessary to grasp the number of times the liquid ejection head has been reused. As in the present disclosure, when the number of times of reuse is written on a packing container that protects and contains the liquid ejection head, the number of times of reuse of the liquid ejection head that is collected together with the storage container can also be known.

For the above-described reasons, in order to maintain the packing reliability of the collected container, it is preferable that a means for knowing the number of times of reuse of the collected container can be achieved at low cost because containers in various states, such as a container that has never been reused, a container that has been reused once, a container that has been reused twice, and a container that cannot be reused, are collected.

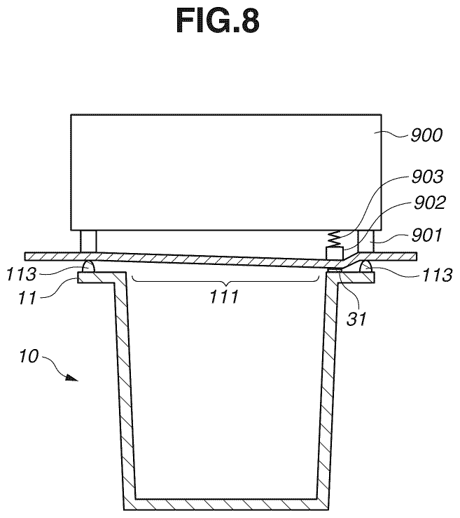

It is desirable that the transfer portion 31 be provided outside the welded region 35 of the surface 30a of the lid member 30 (on the side opposite to the opening 111). The projection 113 often has a height, and the height is often about 0.2 to 0.8 mm. In this case, when the lid member 30 is welded, it is necessary to bring the bonded layer 313 into contact with the flange 11 by pressing down the transfer portion 31 further than the welded region 35. Herein, FIG. 8 illustrates a cross-sectional view of a case where the transfer portion 31 is provided closer to the opening 111 (inner side) than the projection 113. Because the lid member 30 is restrained by being welded to the projection 113 inside the welded region 35, there is a possibility that the lid member 30 is stretched and broken when the transfer portion 31 is intended to be brought into contact with the flange 11. For this reason, it is desirable that the transfer portion 31 be provided outside the projection 113 on the surface 30a of the lid member 30, which is farther from the opening 111 than the projection 113. However, in a case where the lid member 30 is formed of a material having flexibility, even when the transfer portion 31 is provided closer to the opening 111 than the projection 113, the lid member 30 is less likely to be broken.

When the height of the projection 113 is lower than the height of the transfer portion 31, it is necessary to further press down the lid member 30 in the welded region 35 after the transfer portion 31 comes into contact with the flange, which may lead to breakage of the lid member 30. For this reason, it is desirable that the height of the projection 113 be greater than that of the transfer portion 31. In this case, even when a plurality of main bodies 10 each having the transfer portion 31 is stacked in the middle of the manufacturing process or the like, the transfer portion 31 does not become an obstacle.

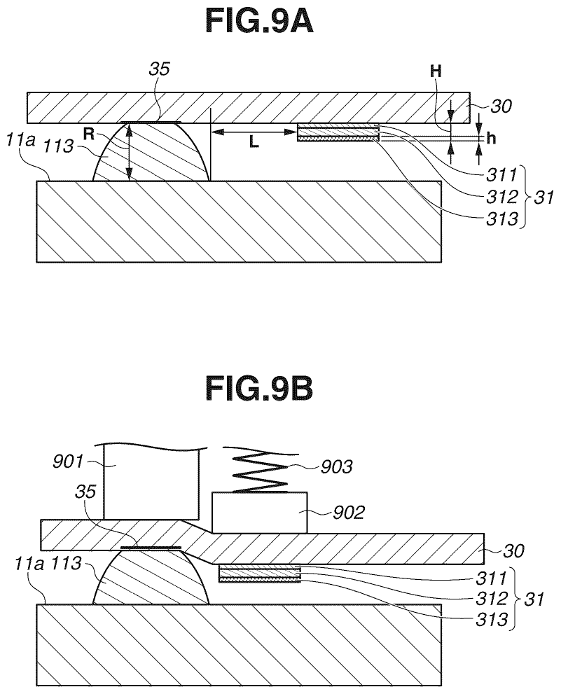

Desirable dimensions of the transfer portion 31 will be described with reference to FIGS. 9A and 9B. Herein, as illustrated in FIG. 9A, in a state where the lid member 30 is welded to the main body 10 (flange 11), the height of the projection 113 in the direction perpendicular to the surface 11a of the flange 11 is R, the height of the transfer portion 31 (release layer 311, fixing layer 312, and bonded layer 313) is H, and a distance in a horizontal direction between the projection 113 and the transfer portion 31 is L. The horizontal direction is a direction parallel to the surface 11a of the flange 11.

When the lid member 30 is welded, it is necessary to bring the bonded layer 313 into contact with the flange 11 by pressing down the portion of the lid member 30 having the transfer portion 31 from the welded region 35. For this reason, as illustrated in FIG. 9B, when the distance L between the projection 113 and the transfer portion 31 is too short, it may be difficult to bring the transfer portion 31 into contact with the flange 11. For example, when R-(H-h)=L, at the time of welding the lid member 30, the bonded layer 313 is melted by heat of the transfer horn 902, and the height of the bonded layer 313 is decreased. Then, due to the decrease in the height H caused by the melting of the bonded layer 313, the pressing of the transfer portion 31 against the flange 11 by the transfer horn 902 becomes insufficient, and a sufficient bonding strength may not be acquired. From the above, it is desirable to set R-(H-h)<L by using a height (H-h) of the transfer portion 31 excluding a height h of the bonded layer 313. The height h may be considered as either a height of the transfer portion 31 before transfer or a height after transfer.

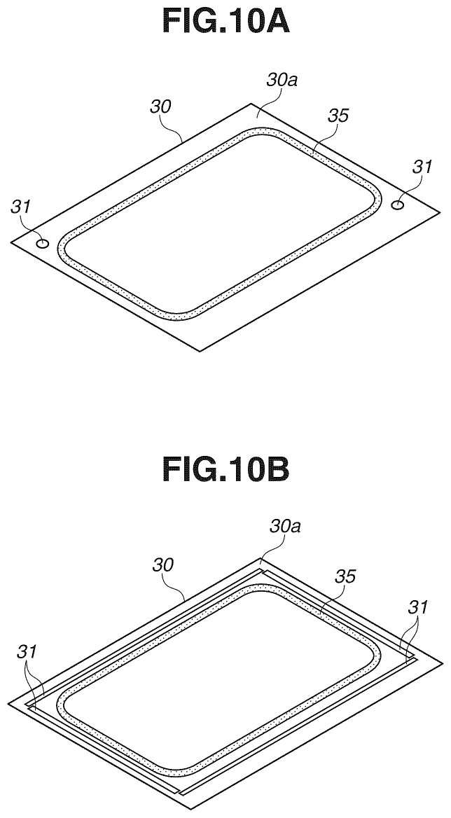

A shape and the number of the transfer portion 31 can be appropriately selected. FIGS. 10A and 10B are diagrams each illustrating an arrangement example of the transfer portion 31 in the lid member 30. For example, as illustrated in FIG. 10A, two or more transfer portions 31 may be provided. As illustrated in FIG. 10B, the transfer portion 31 may be provided in such a way as to surround the outside of the welded region 35.

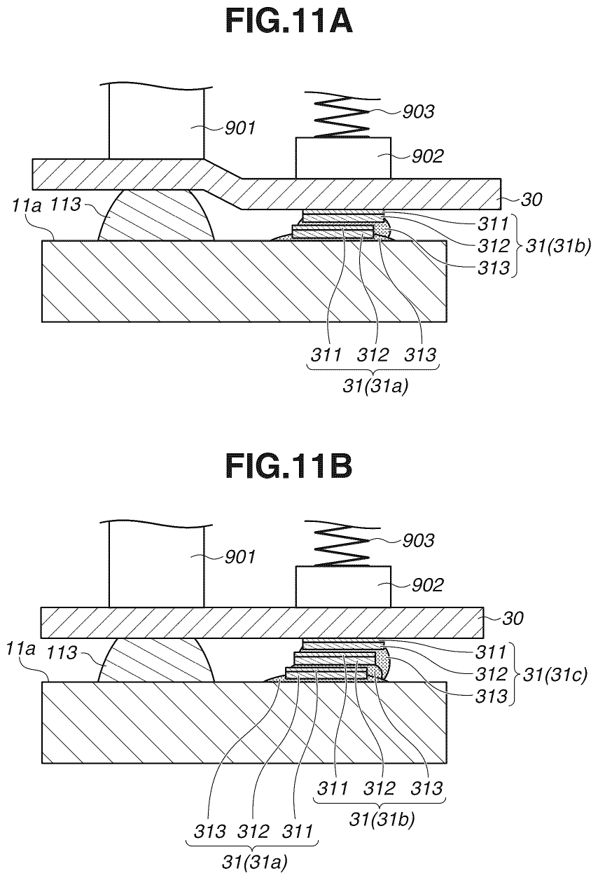

It is desirable that the size of the transfer portion 31 is set to such a size as to overlap with the previously transferred position even if the transfer position is shifted. When the lid member 30 is welded to the main body 10 to be reused, the transfer portion 31 to be newly transferred may be transferred to a position away from the projection 113 due to the influence of the height on the transfer portion 31 that is already transferred to the flange 11. In the example of the main body 10 for the first reuse illustrated in FIG. 11A, the transfer portion 31 (31b) that has been transferred from a new lid member 30 is transferred so as to be shifted in a direction away from the projection 113 with respect to the transfer portion 31 (31a) that is already transferred. Further, in the example of the main body for the second reuse illustrated in FIG. 11B, the transfer portion 31 (31c) transferred from a new lid member 30 is transferred so as to be shifted in a direction further away from the projection 113. The transfer position of the transfer portion 31 to the flange 11 at the time of reuse of the main body 10 may be shifted from the position of the transfer portion 31 on the flange 11 due to a variation in relative position when the main body 10 and the lid member 30 are welded to each other or a variation in dimension of each of the main body 10 and the lid member 30. For this reason, it is desirable to set the size of the transfer portion 31 in consideration of tolerance of a manufacturing apparatus such as a transfer horn in such a way that the transfer portion 31 overlaps with the previously transferred position even if the transfer position is shifted.

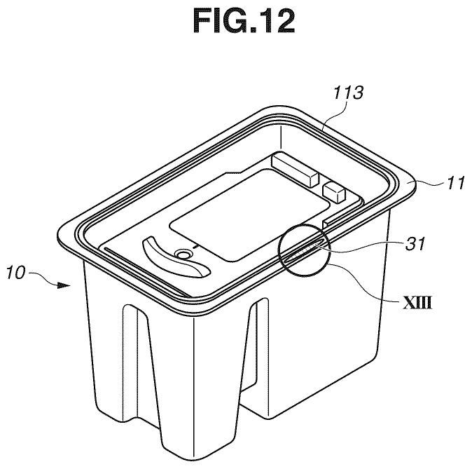

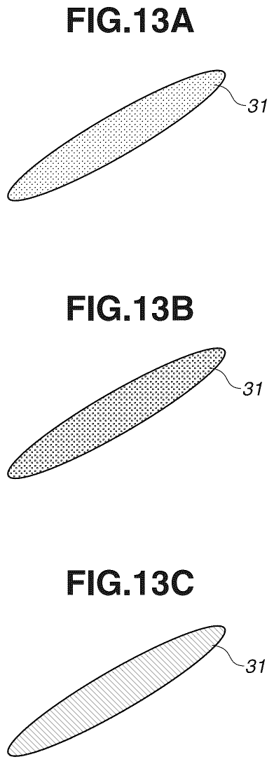

In addition to the height of the transfer portion 31, a color of the transfer portion 31 on the flange 11 can also be used for determining the number of times the main body 10 is reused. FIGS. 12 and FIGS. 13A to 13C each illustrate an example of the main body 10 in which the number of times the main body is reused can be determined by using the color of the transfer portion 31. FIG. 12 is a perspective view of the entire main body 10 to which the transfer portion 31 has been transferred. FIGS. 13A to 13C are enlarged views of the transfer portion 31 of an XIII portion in FIG. 12, and each illustrate the transfer portion 31 that has been transferred onto the flange 11. FIG. 13A illustrates the transfer portion 31 on the main body 10 from which the lid member 30 is peeled off after the lid member 30 is welded to a new main body 10. FIG. 13B illustrates the transfer portion 31 on the main body 10 from which the lid member 30 is peeled off after the lid member 30 is welded to the main body 10 for the first reuse. FIG. 13C illustrates the transfer portion 31 on the main body 10 from which the lid member 30 is peeled off after the lid member 30 is welded to the main body 10 for the second reuse. The transfer portion 31 is colored translucently in a color different from that of the flange 11. As illustrated in FIGS. 13A to 13C, each time the transfer portion 31 is transferred onto the flange 11 in an overlapping manner, transmittance of the transfer portion 31 on the flange 11 decreases and the color thereof becomes dark, and thus it is possible to determine the number of times the main body 10 has been reused, by using the color. The colored portion of the transfer portion 31 may be the fixing layer 312, the bonded layer 313, or the release layer 311 as long as the portion is transferred onto the flange 11.

In the present disclosure described above, by reading the height and the color of the transfer portion 31 transferred to the main body 10, the number of times the main body 10 has been used can be easily determined by the welding process of the lid member 30 and the main body 10. This makes it possible to discriminate between a reusable container and a container that has reached the limit on the number of times of reuse. For this reason, it is possible to reintroduce only a reusable main body 10 to a manufacturing line of the storage container 1 such as a liquid ejection head manufacturing line, and it is possible to reuse the storage container (main body 10) while maintaining packing reliability.

In the present disclosure, since the transfer portion 31 is transferred to the main body 10 from the lid member 30 that is not to be reused, the present disclosure can also be applied when the main body that is already distributed is collected for remanufacturing.

According to the storage container of the present disclosure, a new main body 10 and a collected main body 10 within the limit of the number of times of use can be randomly input to the manufacturing line of the conventional liquid ejection head. In the collection of the storage container (main body 10), containers in various states, such as a container that has never been reused, a container that has been reused once, a container that has been reused twice, and a container that cannot be reused, are collected. For this reason, the present disclosure, in which the storage object can be packed in the same manufacturing line regardless of the number of times of reuse, is preferable in that the storage container can be reused without significantly changing the design of the manufacturing line.

The technology described herein may contribute to achievement of sustainable societies such as decarbonization/recycling societies.

It is possible to provide a storage container capable of recording the number of times the container has been reused, a manufacturing method of the storage container, and a reusing method of the storage container.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-016991, filed Feb. 7, 2024, which is hereby incorporated by reference herein in its entirety.

What is claimed is:

1. A storage container comprising:
a main body including a storage portion having a space for containing a liquid cartridge and a peripheral edge portion forming an opening for containing the liquid cartridge in the storage portion; and
a lid member covering the opening,
wherein the peripheral edge portion includes
a surface facing the lid member,
a welded portion on the surface and welded to the lid member, and
a structure having a first layer bonded to the surface and a second layer stacked on the first layer.

2. The storage container according to claim 1, wherein the welded portion is continuously formed along a circumferential direction of the opening.

3. The storage container according to claim 1, wherein the welded portion has a projection shape.

4. The storage container according to claim 1, wherein the welded portion is arranged closer to the opening than the structure when viewed from a direction perpendicular to the surface.

5. The storage container according to claim 1, wherein the lid member covering the opening is welded to the welded portion.

6. The storage container according to claim 1, wherein the second layer is a release layer.

7. The storage container according to claim 6, wherein the structure includes a third layer between the first layer and the second layer.

8. The storage container according to claim 7, wherein at least one of the first layer, the second layer, or the third layer is colored.

9. The storage container according to claim 1, wherein the liquid cartridge includes a liquid ejection head configured to eject ink.

10. The storage container according to claim 1, wherein a plurality of the structures is stacked on the surface of the peripheral edge portion.

11. A manufacturing method of a storage container including an opening, a main body having an peripheral edge portion forming the opening, and a lid member covering the opening, the manufacturing method comprising:
preparing the main body and the lid member including a structure having a bonded layer;
welding the lid member to the peripheral edge portion; and
transferring the structure from the lid member to the peripheral edge portion.

12. The manufacturing method of a storage container according to claim 11, wherein the peripheral edge portion and the lid member are welded to each other via a welded portion.

13. The manufacturing method of a storage container according to claim 12, wherein the structure is transferred from the lid member to the peripheral edge portion in such a way as to satisfy R-(H-h)>L, where a height of the welded portion is R, a height of the structure is H, and a height of the bonded layer is h, in a direction perpendicular to a surface of the peripheral edge portion facing the lid member, and where a distance between the welded portion and the structure is L, in a direction parallel to the surface.

14. The manufacturing method of a storage container according to claim 11, wherein the transferring includes transferring the structure from the lid member to the peripheral edge portion, the structure including the bonded layer that is bonded to a surface of the peripheral edge portion and a release layer that is in contact with the lid member before the transferring.

15. The manufacturing method of a storage container according to claim 14, wherein the structure having a fixing layer between the bonded layer and the release layer is transferred from the lid member to the peripheral edge portion.

16. The manufacturing method of a storage container according to claim 11, wherein the welding and the transferring are performed at the same time.

17. The manufacturing method of a storage container according to claim 11, further comprising determining a number of times the main body is reused, from a state of the structure on a surface of the peripheral edge portion facing the lid member.

18. The manufacturing method of a storage container according to claim 11, wherein the lid member is welded to the main body in which a liquid ejection head configured to eject liquid is contained.

19. A reusing method of a storage container for containing a liquid cartridge, the storage container including a main body that includes a storage portion having a space for containing the liquid cartridge and an peripheral edge portion forming an opening for containing the liquid cartridge in the storage portion, and a lid member covering the opening, the peripheral edge portion including, on a surface facing the lid member, a welded portion that is welded to the lid member and a structure having a first layer bonded to the surface and a second layer stacked on the first layer, the reusing method comprising:
collecting the main body from which the lid member is peeled off; and
determining a number of times the main body is reused, from a state of the structure.

20. The reusing method of a storage container according to claim 19, wherein the collecting includes collecting the main body in a state where a liquid ejection head configured to eject liquid is contained as the liquid cartridge.
